(19) United States
(12) Patent Application Publication
(10) Pub. No.: US 2014/0354819 A1
(43) Pub. Date: Dec. 4, 2014

(54) RAPIDLY DEPLOYABLE VIDEO SURVEILLANCE SYSTEM

(71) Applicant: Frank Venegas, JR., Bingham Farms, MI (US)

(72) Inventor: Frank Venegas, JR., Bingham Farms, MI (US)

(21) Appl. No.: 14/294,616

(22) Filed: Jun. 3, 2014

Related U.S. Application Data
(60) Provisional application No. 61/830,475, filed on Jun. 3, 2013.

(51) Int. Cl. H04N 7/18

(52) U.S. Cl. CPC H04N 7/183; H04N 7/185
USPC 348/151; 348/143

(57) ABSTRACT

A rapidly deployable video monitoring system for surveillance purposes, for example, comprises a portable sign base including an upright vertical member, and at least one video camera coupled to the sign base or vertical member. The system may further include one or more signs fastened to the upright vertical member. The camera may be conspicuous or visually obscured, depending upon the deployed environment. The camera, which may be a still camera or a video recorder, may wirelessly communicate with a monitoring station. Personnel in the monitoring station may be able to control the pan, tilt, or zoom of the camera.

### REFERENCE TO RELATED APPLICATION

This application claims priority to U.S. Provisional Patent Application Ser. No. 61/830,475, filed Jun. 3, 2013, the entire content of which is incorporated herein by reference.

### FIELD OF THE INVENTION

This invention relates generally to video surveillance and, in particular, to a mobile, rapidly deployed system that uses portable sign bases and vertical poles.

### BACKGROUND OF THE INVENTION

The bombings at the Boston marathon underscored the value of video recordings for suspect identification. Within hours of the incident, video captures form cell phones and surveillance cameras were delivered to authorities, enabling rapid apprehension of the perpetrators.

However, it would be even more effective if the video footage came from purposefully placed cameras as opposed to the ad hoc use of cell phones and permanently placed cameras which may, or may not, acquire the most valuable sequences of individuals in the crowd.

While there are portable surveillance systems, they tend to be prominent and conspicuous. U.S. Pat. No. 4,815,757 discloses a rapid deployment surveillance vehicle detecting illegal immigration across national borders and the like. An off-the-road vehicle is equipped with a rapid mast erection/retraction assembly which includes a carriage mechanism carrying a telescoping mast. A track mechanism slidably carries the carriage mechanism by means of a fixed support and pivoting support arms. Ram air cylinders move the carriage mechanism in translational and rotational movement as guided on the track mechanism in a manner that the mast is moved from a stowed horizontal position to an erect vertical position. Once the vehicle is within the prescribed level conditions, a mast is pneumatically extended to a height of thirty feet whereupon a detection device which may be in the form of an infrared camera is ready for surveillance. The camera is mounted on a pan/tilt device which rotates it in a horizontal plane and tilts it in a vertical plane for increased surveillance. With the mast within one degree of true vertical, a stable platform is provided for camera so that a non-distorted image appears on the display of a monitor remote from the camera.

U.S. Pat. No. 7,089,705, for example, discloses a portable surveillance system having a skid-type base structure that forms a support for a portable tower apparatus. Stabilizers are extendably mounted to the base structure. The tower components include a base member affixed to the base plate, a pivot bracket affixed to an upper end of the base member, a tower member pivotally mounted to the pivot bracket on the base member and one or more removable tower members that may be installed to achieve a desired height for the tower once it is pivoted to an upright orientation by manipulating a cable and pulley system. Various equipment mounts are provided on the tower to mount equipment such as an aerometer, a tower light, a wind direction vane, a video camera, a microwave telecom dish, or other equipment thereon. The ability to rapidly deploy the tower of invention enables rapid deployment for surveillance and other uses.

Similarly, U.S. Pat. No. 7,852,211 provides a mobile surveillance and security system having one or more power sources, such as an alternator, a photovoltaic array, a fuel cell, or the like, and a surveillance apparatus, such as a closed circuit camera, an IP camera, a motion sensor, a microphone, a radiation sensor, a temperature sensor, a weather sensor, or the like, electrically coupled to the power source. The mobile system can further include a frame, a wheel supporting the frame, and a structure (e.g., an expandable tower) supported by the frame. The power source can be supported by the frame and the surveillance apparatus can be supported by the structure. The mobile system can further include a security apparatus electrically coupled to the power source and in communication with the surveillance apparatus. The security apparatus can be electrically coupled to the power source (e.g., directly, via a battery, etc.). Example security apparatus can include an audible alarm; a visual alarm; a communication to an apparatus distinct from the mobile system; or the like. The mobile system can further include a communication apparatus electrically coupled to the power source and in communication with the surveillance apparatus and the security apparatus.

U.S. Pat. No. 6,709,171, entitled “Temporary Surveillance System,” includes a platform having a plurality and variety of cameras or sensors mounted thereto, and a base enclosure adapted to accommodate a power supply, a variety of electronics and other equipment for controlling and providing power to the surveillance equipment. The base is constructed to be tamper resistant and immovable by manual means. A substantially hollow support pole includes a lower portion detachably mounted to the base, and an upper portion mounted to the platform. Wires and cables for connecting the surveillance equipment with the electronics and power supply are run through the support pole. Power to the system may be supplied through existing power sources, for example a 120 V power source. While “temporary,” the system does not appear to be mobile.

The portable surveillance system for rapid deployment disclosed in U.S. Pat. No. 8,007,189 comprises a hardware case containing a battery, a processor, a hard disk drive, and a means for communications; at least one surveillance camera; and a tripod. The tripod is used to support both the camera and the hardware case. The hardware case is weatherproof, having, intake and exhaust fans and optional electric heating and/or cooling units. The present invention is capable of being transported and positioned quickly by a single operator in a desired location.

### SUMMARY OF THE INVENTION

This invention is directed to a rapidly deployable video monitoring system for surveillance purposes, for example. The system broadly comprises a portable sign base including an upright vertical member, and at least one video camera coupled to the sign base or vertical member. The system may further include one or more signs fastened to the upright vertical member. The camera may be conspicuous or visually obscured, depending upon the deployed environment. The camera, which may be a still camera or a video recorder, may wirelessly communicate with a monitoring station. Personnel in the monitoring station may be able to control the pan, tilt, or zoom of the camera.

### BRIEF DESCRIPTION OF THE DRAWINGS

FIG. 1 is a drawing of a sign support 100 applicable to the invention; and

FIG. 2 is a drawing that illustrates one possible installation according the invention.

### DETAILED DESCRIPTION OF THE INVENTION

This invention makes use of portable sign bases with vertical poles to implement a rapidly deployable video surveillance system particularly applicable to events that temporarily draw large crowds.

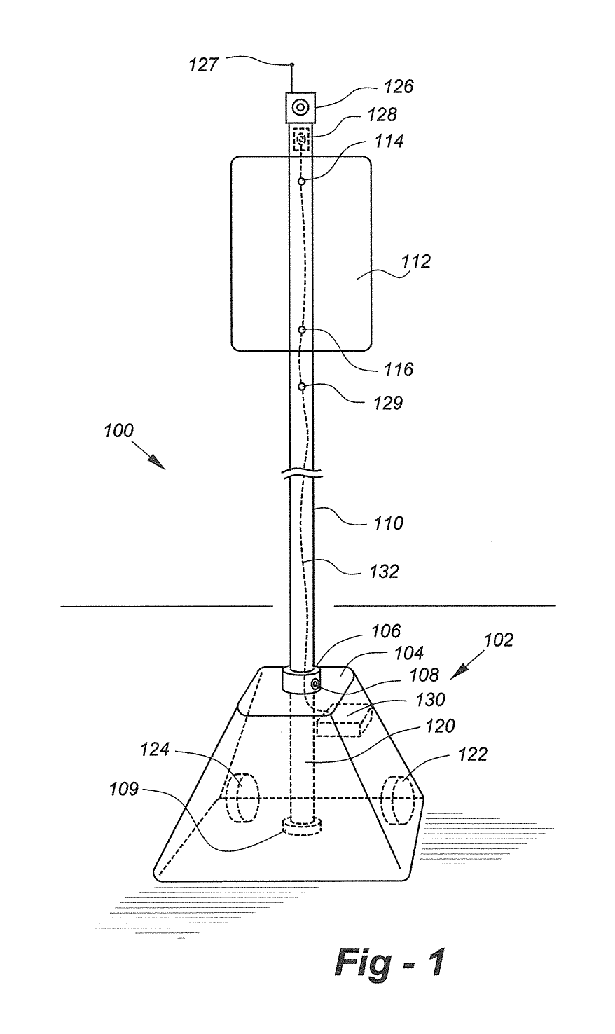

FIG. 1 is a drawing of a sign support 100 applicable to the invention. The apparatus 100 includes a sign base 102 coupled to a generally vertical pole 110 to which a sign 112 may be attached via fasteners 114, 116. The base 102 preferably includes an upper surface 104 including a collar 106 into which pole 110 is inserted and locked into position with fastener 108.

The base 102 is preferably made of durable plastic, whereas the pole 110 is preferably a metal such as steel. The inside of base 102 may include a lower collar 109 to receive the lower end of the pole 110 for added stability. The base may be filled with a ballast material such as sand, water, or a sand/water mix to add weight and balance. The base may include wheels 122, 124 enabling the unit to be tilted slightly and moved into and out of position.

In accordance with the invention, the sign base and pole assembly includes one or more video cameras 126. While such camera(s) may be wired to a remote viewing and/or recording facility, in the preferred embodiments the camera 126 either transmits the video wirelessly via antenna 127 or is entirely self-contained with sufficient video storage that the camera may be interrogated during or after an event to obtain the footage. To protect camera electronics, a recorder, battery pack or other hardware 130 may be disposed in the base 102, with wiring 132 being included for communication to the camera(s).

The camera may be conspicuous, hidden, or both. For example, a camera such as unit 126 may be visible and obvious and, in fact, sign 112 may refer to the existence of the camera(s) with a message such as NOTICE-THIS AREA UNDER VIDEO SURVEILLANCE; SMILE, YOUR ON CAMERA, and so forth. Alternatively, the camera(s) may be hidden in the pole at 128 or 129, in which case the signage may have nothing to do with video monitoring.

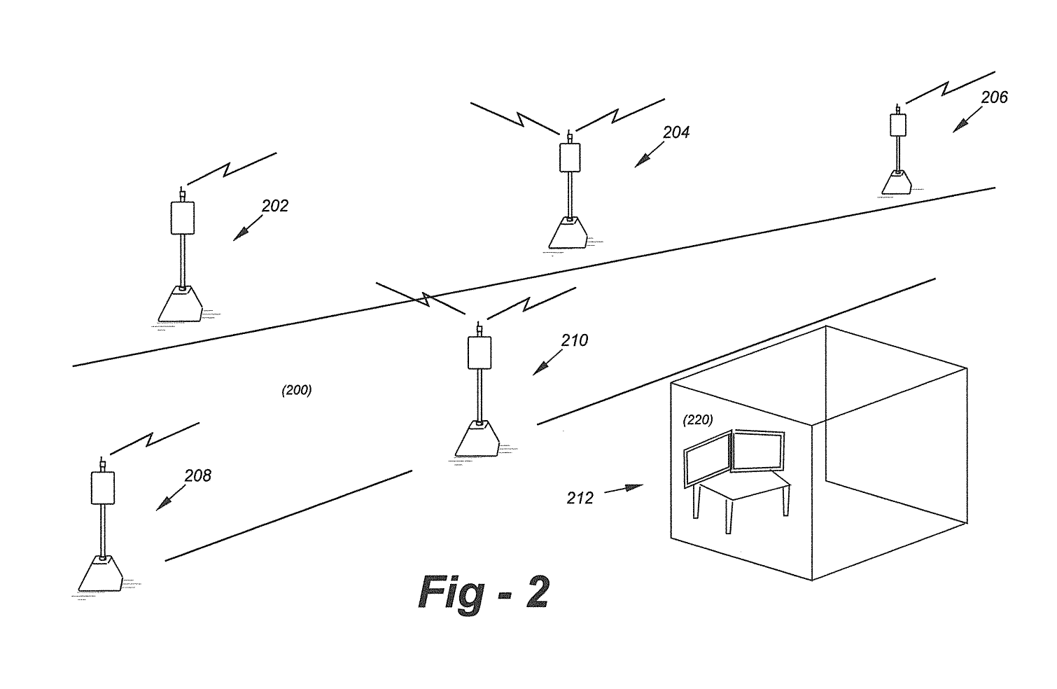

FIG. 2 is a drawing that illustrates one possible installation according the invention. In this environment, a plurality of cameras 202, 204, 206, 208, 210 are positioned along a road 200 wherein a crowd will assemble (not shown). The cameras communicate wirelessly to a monitoring station 212 including one or more viewing screens 220. The camera(s) used in the invention may be equipped with any advanced capabilities including, but not limited to wide-angle/360-degree field of view, remote control of pan, tilt and/or zoom. The monitoring station may also be equipped with advanced tools such as facial recognition software, interfaces to law-enforcement databases, and so forth.

1. A rapidly deployable video monitoring system, comprising:
a portable sign base including an upright vertical member; and
a video camera coupled to the sign base or vertical member.

2. The system of claim 1, further including a sign fastened to the upright vertical member.

3. The system of claim 1, wherein the camera is conspicuous.

4. The system of claim 1, wherein the camera is visually obscured.

5. The system of claim 1, wherein the camera includes a video recorder.

6. The system of claim 1, wherein the camera wirelessly communicates with a monitoring station.

7. The system of claim 1, wherein:
the camera wirelessly communicates with a monitoring station; and
the monitoring station is able to control the pan, tilt, or zoom of the camera.
